(19) United States
(12) Patent Application Publication
(10) Pub. No.: US 2026/0086915 A1
(43) Pub. Date: Mar. 26, 2026

(54) ELECTRONIC DEVICE, LOG GENERATION METHOD, AND RECORDING MEDIUM

(71) Applicant: CASIO COMPUTER CO., LTD., Tokyo (JP)

(72) Inventors: Erina ICHIKAWA, Tokyo (JP); Hirokazu HASEGAWA, Tokyo (JP); Kouki MAYUZUMI, Tokyo (JP); Shunsuke YAMADA, Tokyo (JP)

(73) Assignee: CASIO COMPUTER CO., LTD., Tokyo (JP)

(21) Appl. No.: 19/333,761

(22) Filed: Sep. 19, 2025

(30) Foreign Application Priority Data
Sep. 20, 2024 (JP) 2024-163623

(51) Int. Cl. G06F 11/34; G06F 8/65; G06F 11/30

(52) U.S. Cl. CPC G06F 11/3476; G06F 8/65; G06F 11/3013

(57) ABSTRACT

Disclosed is an electronic device including one or more processors configured to: generate first logs at respective periodic times for respective first periods of a predetermined length, the first logs containing at least information related to an operation history of the electronic device during the respective first periods; and, in response to the electronic device executing a special process that is capable of preventing one of the first logs from being generated at a corresponding periodic time, execute a predetermined process to generate a second log for a second period from a last periodic time before the corresponding periodic time to a time before a start of the special process. The second log contains at least the information related to the operation history of the electronic device during the second period.

### REFERENCE TO RELATED APPLICATIONS

This application claims priority and benefits of Japanese Patent Application No. 2024-163623, filed on September 20, 2024. The specification, claims, and drawings of Japanese Patent Application No. 2024-163623 are incorporated herein by reference in their entirety.

### TECHNICAL FIELD

This disclosure relates to an electronic device, a log generation method, and a recording medium.

### DESCRIPTION OF RELATED ART

For electronic devices, such as robots, there is known technology for periodically generating logs related to their history, such as operation history, and using these logs for various analyses (e.g., JP 2024-510605A).

### SUMMARY OF THE INVENTION

An electronic device according to the present disclosure comprises one or more processors configured to: generate first logs at respective periodic times for respective first periods of a predetermined length, the first logs containing at least information related to an operation history of the electronic device during the respective first periods; and, in response to the electronic device executing a special process that is capable of preventing one of the first logs from being generated at a corresponding periodic time, execute a predetermined process to generate a second log for a second period from a last periodic time before the corresponding periodic time to a time before a start of the special process, wherein the second log contains at least the information related to the operation history of the electronic device during the second period.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating an appearance of a robot and a smartphone;

FIG. 2 is a schematic diagram illustrating a configuration of a main body of the robot;

FIG. 3 is a block diagram illustrating a functional configuration of the robot;

FIG. 4 is a block diagram illustrating a functional configuration of the smartphone;

FIG. 5 is a diagram illustrating the contents of a log;

FIG. 6 is a diagram illustrating how logs are generated when log transfer is executed as a special process;

FIG. 7 is a diagram illustrating how logs are generated when the log transfer is executed as a special process;

FIG. 8 is a diagram illustrating how logs are generated when a FW update is executed as a special process; and

FIG. 9 is a flowchart illustrating a control procedure of a log generation process.

### DETAILED DESCRIPTION

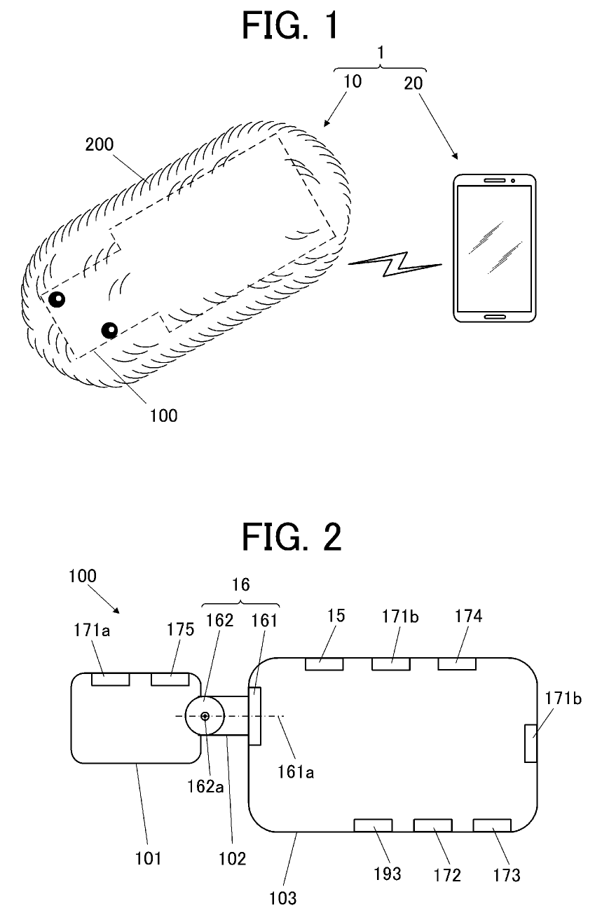

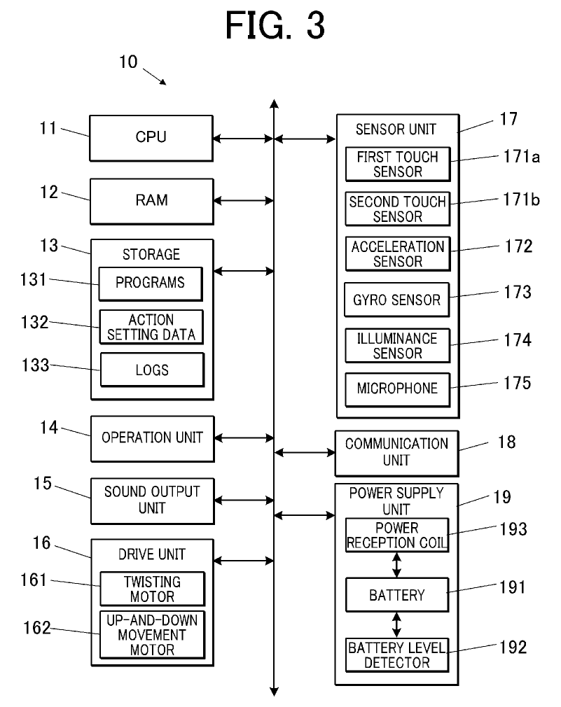

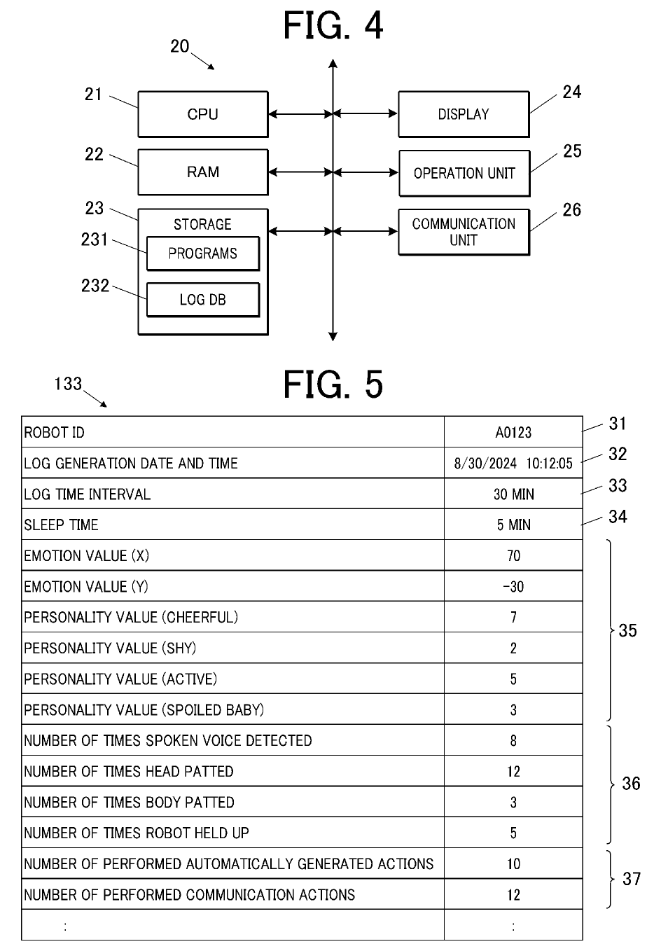

Hereinafter, one or more embodiments of the present invention will be described with reference to the drawings. However, the scope of the invention is not limited to the disclosed embodiments. As illustrated in FIG. 1, a robot management system 1 includes a robot 10 (electronic device) and a smartphone 20 (management device, external device). The robot 10 includes a main body 100 and an exterior 200 that covers the entire surface of the main body 100. The robot 10 is a pet robot modeled after a small creature. The robot 10 can perform a plurality of different actions that imitate the gestures of a living being. The exterior 200 is made of a flexible material and is deformed according to the movement of the main body 100. The exterior 200 includes, for example, fur formed from pile fabric, decorative components imitating eyes, and the like. The smartphone 20 is capable of communicating with the robot 10 via short-range wireless communication. In the present embodiment, Bluetooth (registered trademark) Low Energy (BLE) is used as the short-range wireless communication. However, a short-range wireless communication method other than BLE may be used. The robot 10 and the smartphone 20 communicate with each other via BLE to transmit and receive data, thereby operating in coordination with each other. For example, a log 133 (see FIGS. 3 and 5) generated by the robot 10 is transmitted to the smartphone 20 to be stored in log database (DB) 232 (see FIG. 4). In addition, on an application program for robot management installed on the smartphone 20, information related to the history of the robot 10 can be generated by analyzing the log DB 232 and displayed on a display 24 of the smartphone 20. Hereinafter, the application program for robot management is referred to as "management application". Instead of the smartphone 20, another type of device (including a computer program product) such as a tablet device, a smart watch, a laptop PC, or a management server may be used.

As illustrated in FIG. 2, the main body 100 of the robot 10 includes a head 101, a torso 103, and a connector 102 that connects the head 101 and the torso 103 to each other. The main body 100 includes a drive unit 16 that moves the head 101 relative to the torso 103. The drive unit 16 includes a twisting motor 161 and an up-and-down movement motor 162. The twisting motor 161 is a servo motor that rotates the head 101 and the connector 102 within a predetermined angle range around a first rotation axis 161a extending in an extending direction of the connector 102. The twisting motor 161 enables the robot 10 to twist the head 101. The up-and-down movement motor 162 is a servo motor that rotates the head 101 within a predetermined angle range around a second rotation axis 162a perpendicular to the first rotation axis 161a. The up-and-down movement motor 162 enables the robot 10 to move the head 101 up and down. The up-and-down movement direction of the head 101 can also be inclined with respect to the vertical direction depending on a twisting angle of the head 101 by the twisting motor 161. By operating the twisting motor 161 and/or the up-and-down movement motor 162 in a fine, periodic manner, the robot 10 can swing or shake the head 101. By suitably changing and combining the timings, amounts, and speeds of the operations of the twisting motor 161 and the up-and-down movement motor 162, it is possible to cause the robot 10 to perform various actions, such as an action of joy, an action of surprise, and a breathing action that imitates the breathing of a living being. Among them, the breathing action is one form of a spontaneous action performed by the robot 10.

As illustrated in FIG. 2, the main body 100 includes a first touch sensor 171a, second touch sensors 171b, an acceleration sensor 172, a gyro sensor 173, an illuminance sensor 174, a microphone 175, a sound output unit 15, and a power reception coil 193. The first touch sensor 171a is disposed in an upper portion of the head 101. The second touch sensors 171b are disposed in an upper portion and a side surface of the torso 103. Hereinafter, the term "touch sensor 171" is used when referring to any one of the first touch sensor 171a and the second touch sensors 171b. The acceleration sensor 172, gyro sensor 173, and power reception coil 193 are disposed adjacent to a bottom surface of the torso 103. The illuminance sensor 174 and the sound output unit 15 are disposed in the upper portion of the torso 103. The microphone 175 is disposed in the upper portion of the head 101, adjacent to the base of the head 101.

As illustrated in FIG. 3, the robot 10 includes one or more central processing units (CPUs) 11 as processors, a random-access memory (RAM) 12, a storage 13, an operation unit 14, the sound output unit 15, the drive unit 16, a sensor unit 17, a communication unit 18, and a power supply unit 19. The components of the robot 10 are coupled to each other via a data transmission path such as a bus. Each functional configuration illustrated in FIG. 3 is provided in the main body 100.

The CPU 11 is a processor that reads and executes programs 131 stored in the storage 13 to execute various arithmetic processing, thereby controlling the actions of the robot 10. The robot 10 may include a plurality of processors (e.g., a plurality of CPUs), and the plurality of processors may execute a plurality of processes executed by the CPU 11 according to the present embodiment. In this case, the plurality of processors serves as one or more processors. In addition, the plurality of processors may be involved in a common process, or the plurality of processors may independently execute different processes in parallel. The RAM 12 provides a working memory space for the CPU 11 and stores temporary data.

The storage 13 is a non-transitory recording medium readable by the CPU 11 serving as a computer and stores the programs 131 and various data. Thus, the storage 13 contains a computer program product that includes the programs 131. The storage 13 includes, for example, a nonvolatile memory such as a flash memory. Each of the programs 131 is stored in the storage 13 in the form of a computer-readable program code. The programs 131 include firmware for controlling each piece of hardware of the robot 10. The data stored in the storage 13 includes action setting data 132 and the log 133 that contains the information related to the history of the robot 10. The action setting data 132 sets action contents, such as a communication action that the robot 10 performs in response to the state of the robot 10 or an external stimulus, and an automatically generated action and a breathing action that the robot 10 spontaneously performs regardless of an external stimulus. The automatically generated action can also be called a whimsical action, as the automatically generated action makes it look like the robot 10 is making a gesture on a whim. Settings related to the action contents include, for example, settings of the operation timing and operation amount of the twisting motor 161 and the up-and-down movement motor 162 of the drive unit 16, settings of the pitch, length, and volume of a sound output by the sound output unit 15, and the like. The specific contents of the log 133 will be described later.

The operation unit 14 includes operation buttons, operation knobs, and the like for turning the power on and off, as well as for adjusting the volume of a sound output by the sound output unit 15. The operation unit 14 outputs operation information to the CPU 11 according to an input operation on the operation buttons and the operation knobs. The sound output unit 15 includes a speaker and outputs a sound at a pitch, length, and volume corresponding to a control signal and sound data transmitted from the CPU 11. The sound may be a sound that imitates the cry of a living being. The drive unit 16 drives the twisting motor 161 and the up-and-down movement motor 162 according to the control signal transmitted from the CPU 11.

The sensor unit 17 includes the first touch sensor 171a, second touch sensors 171b, acceleration sensor 172, gyro sensor173, illuminance sensor 174, and microphone 175. The sensor unit 17 outputs a detection result from each of the sensors and microphone 175 to the CPU 11. The touch sensor 171 detects a contact of a user or another object with the robot 10. The touch sensor 171 includes, for example, a pressure sensor, or a capacitance sensor and outputs detection data regarding the presence or absence of a contact with the robot 10 to the CPU 11. The acceleration sensor 172 detects acceleration in each of three orthogonal axial directions and outputs detection data to the CPU 11. The gyro sensor 173 detects angular velocity around each of the three orthogonal axial directions and outputs detection data to the CPU 11. The illuminance sensor 174 detects brightness around the robot 10 and outputs detection data to the CPU 11. The microphone 175 detects a sound around the robot 10 and outputs detected sound data to the CPU 11.

The communication unit 18 is a communication module that includes an antenna, modulation/demodulation circuit, signal processing circuit, and the like, and performs wireless data communication with the smartphone 20 according to the BLE communication standard.

The power supply unit 19 includes a battery 191, a battery level detector 192, and a power reception coil 193. The battery 191 supplies power to each component of the robot 10. The battery 191 according to the present embodiment is a secondary battery that can be repeatedly charged by a non-contact charging method. The battery level detector 192 detects the battery level of the battery 191 according to a control signal transmitted from the CPU 11 and outputs a detection result to the CPU 11. The battery 191 is charged while the robot 10 is stored (installed) in a dedicated power feeder (holder, charging dock, not shown). The power feeder includes a power transmission coil for charging the battery 191 by electromagnetic induction at a position facing the power reception coil 193 when the robot 10 is stored in the power feeder.

As illustrated in FIG. 4, the smartphone 20 includes a CPU 21, a RAM 22, a storage 23, a display 24, an operation unit 25, and a communication unit 26. The components of the smartphone 20 are coupled to each other via a data transmission path such as a bus.

The CPU 21 is a processor that reads and executes programs 231 stored in the storage 23 to execute various arithmetic processing, thereby controlling the operation of the smartphone 20. The smartphone 20 may include a plurality of processors, for example, a plurality of CPUs. The RAM 22 provides a working memory space for the CPU 21 and stores temporary data. The storage 23 is a non-transitory recording medium readable by the CPU 21 serving as a computer and stores the programs 231 and various data. The storage 23 includes, for example, a nonvolatile memory such as a flash memory. The programs 231 include the management application described above. The data stored in the storage 23 includes the log DB 232 described above.

The display 24 includes a display panel, such as a liquid crystal panel, capable of dot matrix display, and a drive circuit for the display panel. The display 24 displays various menus, application screens, and the like according to control signals sent from the CPU 21. The operation unit 25 includes operation means, such as a touch panel provided so as to overlap the display panel of the display 24, and operation buttons. The operation unit 25 outputs an operation signal corresponding to an operation on the operation means to the CPU 21. The communication unit 26 is a communication module that includes an antenna, modulation/demodulation circuit, signal processing circuit, and the like, and performs wireless data communication with the robot 10 according to the BLE communication standard. The communication unit 26 transmits and receives voice data for telephone communication and packet data related to Internet connection, and the like to and from a base station.

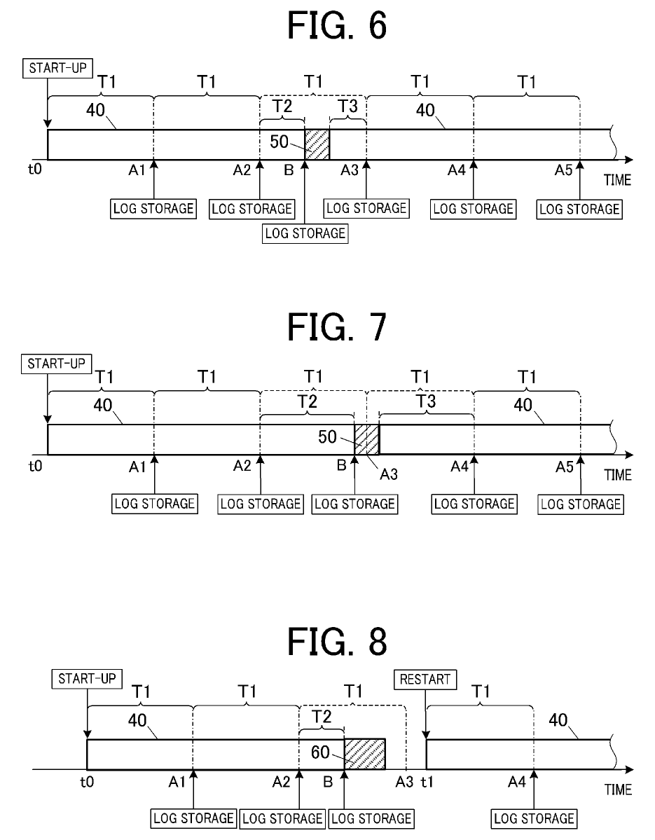

Next, the operation of the robot 10 will be described. The CPU 11 of the robot 10 according to the present embodiment generates logs 133 containing the information related to the history of the robot 10 at respective periodic times A (A1, A2, and so forth shown in FIGS. 6 to 8) for respective first periods T1 (see FIGS. 6 to 8) of a predetermined length and stores the generated log in the storage 13. A single log 133 generated at a certain periodic time A contains the information related to the history of the robot 10 during the first period T1 that ends at the certain periodic time A. The history of the robot 10 includes at least an action history (operation history) of the robot 10 and may include a history other than the action history. Hereinafter, an operation of generating a single log 133 and storing the generated log 133 in the storage 13 at a certain time is referred to as "log storage". The log 133 containing the information related to the history of the robot 10 during a certain period is also referred to as a "log 133 for a certain period".

As illustrated in FIG. 5, a log 133 generated in one log storage contains a robot ID 31, log generation date and time 32, log time interval information 33 (time information), state time information 34, state information 35, stimulus count information 36, action count information 37, and the like. The robot ID 31 is a unique code assigned to the robot 10. The log generation date and time 32 is the date and time (hours, minutes, and seconds) when the log 133 is generated. The log time interval information 33 indicates the length of the log recording period for which the history reflected in the log 133 has been recorded. The log recording period is normally the first period T1 as described above but may also be a second period T2 or a third period T3 as described below. In FIG. 5, the log time interval information 33 is recorded in units of minutes but is not limited thereto. The log time interval information 33 may be recorded in units of seconds. The state time information 34 indicates the length of a period during which the robot 10 has been in a predetermined state in the log recording period. In FIG. 5, sleep time is exemplified as the state time information 34. The sleep time is the length of a period during which the robot 10 has been in a sleep mode, which mimics the sleep of a living being. The state information 35 represents the state of the robot 10 at a predetermined time point in the log recording period (e.g., at the beginning of the log recording period). In FIG. 5, emotion value and personality value are exemplified as the state information 35. The emotion value represents a pseudo emotion of the robot 10 by the position of a plot on an emotion map in the XY coordinate plane. The emotion value (X) represents the position in the X-axis direction of the plot. Larger values indicate a higher level of security, while smaller values indicate a higher level of anxiety. The emotion value (Y) represents the position in the Y-axis direction of the plot. Larger values indicate a higher level of excitement, while smaller values indicate a higher level of lethargy. The personality value represents a pseudo personality of the robot 10 by four parameters of "cheerful", "shy", "active", and "spoiled baby". The personality value (cheerful) represents the ease of change in the positive X-axis direction on the emotion map, i.e., the ease of security. The personality value (shy) represents the ease of change in the negative X-axis direction on the emotion map, i.e., the ease of anxiety. The personality value (active) represents the ease of change in the positive Y-axis direction on the emotion map, i.e., the ease of excitement. The personality value (spoiled baby) represents the ease of change in the negative Y-axis direction on the emotion map, i.e., the ease of lethargy. The stimulus count information 36 indicates the number of times the robot 10 has received a predetermined stimulus from the outside during the log recording period. In FIG. 5, as the stimulus count information 36, the number of times a spoken voice has been detected, the number of times the head has been patted, the number of times the body has been patted, and the number of times the robot has been held up are exemplified. Instead of the number of times the robot 10 has received the stimulus, a numerical value indicating the frequency of the stimulus that the robot 10 has received may be recorded. The action count information 37 indicates the number of times the robot 10 has performed a predetermined action during the log recording period. In FIG. 5, the number of times the robot 10 has performed each of the automatically generated action and communication action described above is exemplified as the action count information 37. Instead of the number of times the robot 10 has performed the action, a numerical value indicating the frequency of the action that the robot 10 has performed may be recorded. The log 133 in FIG. 5 is an example and may be changed as appropriate. For example, the number of transitions to an attachment mode, which is a mode that the robot 10 enters when the robot 10 becomes attached to the user, the number of times the robot 10 has received a stimulus from the user in the attachment mode, and the number of times the robot has performed a predetermined action in the attachment mode may be recorded in a log 133.

Thus, the log 133 does not have a format in which the state, the action, the received stimulus, and the like of the robot 10 are sequentially recorded in chronological order. Instead, the log 133 has a format in which each of the state, the action, the received stimulus, and the like of the robot during a certain log recording period is summarized into a statistical value (number of times, frequency, length of a period, or the like) or a representative value (emotion value, personality value, or the like). In other words, the log 133 has a package format in which the history of the robot 10 during the log recording period is summarized into a predetermined number of items. This greatly reduces the amount of data in a log 133 compared to a log in a sequential recording format.

A log 133 is transferred from the robot 10 to the smartphone 20 in response to a transfer request from the smartphone 20. The transfer request of a log 133 is transmitted from the smartphone 20 to the robot 10, for example, when the user instructs the smartphone 20 to acquire the latest log 133 on the management application. The log 133, which has been transferred to the smartphone 20, is accumulated in the log DB 232 and used for action analysis of the robot 10, and the like. In other words, the CPU 21 of the smartphone 20 analyzes the history of the robot 10 based on the latest log DB 232 on the management application and causes the display 24 to display various information related to the analysis results. For example, the CPU 21 causes the display 24 to display the state of interaction between the robot 10 and the user, the transitions of emotion values and personality values, and the like.

The log 133 in the package format can describe the history in a standardized format regardless of the status of robot 10 during the log recording period. This allows the amount of data per one log 133 (the amount of data to be generated in each log 133) to become substantially constant. Therefore, the maximum number of logs 133 that can be stored in the storage 13 is roughly determined according to the storage capacity of the storage 13. Accordingly, the first period T1 has such a length that allows logs 133 generated for respective first periods T1 over a predetermined recording period to be stored in the storage 13. Specifically, the number of logs 133 that can be stored in the storage 13 according to the present embodiment is approximately 1,440, and in order to secure a recording period of 30 days, the first period T1 is set to 30 minutes (30 × 24 × 60 / 1,440). Here, the number of logs 133 that can be stored in the storage 13 is the value obtained by dividing the storage capacity of the storage 13 by the data amount (average or maximum value) in one log 133. On the 31st day or later, when a new log 133 is generated while there is no more space available in the storage 13, the oldest log 133 is deleted and the new log 133 is stored. In this way, the history of the robot 10 for the past 30 days is recorded in the package-format logs 133. The length of the first period T1 may be predetermined and stored in the storage 13 at the time of shipment. The length of the first period T1 may be changeable in response to a predetermined operation by the user on the operation unit 14. The CPU 11 may determine the length of the first period T1 based on the storage capacity of the storage 13 so that logs 133 can be generated over a predetermined recording period.

However, at an irregular (non-periodic) time, the robot 10 may executes a special process that may prevent a log 133 from being generated. When the robot 10 is executing the special process at a periodic time A at which a log 133 is supposed to be generated for the first period T1, the log 133 is not generated at the periodic time A. As a result, a blank period occurs in the record of the history of the robot 10. Examples of the special process include a process related to the transition of the operating mode of the robot 10, and a process related to automatic power-off when a voltage drop, a temperature abnormality, or the like is detected. The process related to the transition includes a process related to the transition from the normal mode to a different mode and a process related to the transition from the different mode to the normal mode. The normal mode corresponds to a period during which the automatically generated action and the communication action described above can be performed, as well as a period during which a log 133 can be generated. Examples of the different mode include a "log transfer mode" for transferring a log 133 to the smartphone 20 in response to a request from the smartphone 20, and a "firmware update mode" for updating the firmware (hereinafter abbreviated as "FW") incorporated in the robot 10. In each of the log transfer mode and the FW update mode, the CPU 11 cannot generate a log 133 not only during the transition to the mode but also during the mode (i.e., during the execution of the special process related to the mode).

In order to reduce the blank period in the history caused by the special process as much as possible, the CPU 11 of the robot 10 according to the present embodiment executes the log storage in the following manner. First, with reference to FIGS. 6 and 7, a case where the special process is the log transfer in the log transfer mode will be described as an example. In FIG. 6, after the robot 10 is started at time t0, while the robot 10 is operating in a normal mode 40, the CPU 11 performs the log storage at periodic times A1 and A2 for respective first periods T1 (30 minutes). When the CPU 11 receives a request to transfer logs 133 from the smartphone 20, the CPU 11 changes the operating mode from the normal mode 40 to a log transfer mode 50. When the robot 10 performs the transition to the log transfer mode 50 as the special process, the CPU 11 performs irregular (non-periodic) log storage at a non-periodic time B prior to the transition to the log transfer mode 50. That is, at the non-periodic time B, which is different from any one of the periodic times A1, A2, and so forth and a time before the start of the special process, the CPU 11 generates a log 133 containing the information related to the history during the second period T2 from the previous periodic time A2 to the time before the start of the special process (i.e., from the previous periodic time A2 to the non-periodic time B) and stores the generated log 133 in storage 13. The non-periodic time B is set to be within a predetermined period immediately before the start of special process. For example, the predetermined time period may be less than 10 seconds before the start of the special process. When generating the log 133 at the non-periodic time B, the CPU 11 records the log time interval information 33 related to the length of the second period T2 in the log 133. For example, when generating the log 133 at the non-periodic time B 14 minutes after the periodic time A2 in FIG. 6, the CPU 11 records "14 minutes" as the log time interval information 33 in the log 133. The process of generating the log 133 for the second period at the non-periodic time B is one aspect of a "predetermined process to generate a log for the second period". The logs 133 generated at the periodic times A1 and A2 may be distinguished as "first logs" and the log 133 generated at the non-periodic time B may be distinguished as a "second log".

The CPU 11 then changes the operating mode to the log transfer mode 50 and transfers the logs 133 to the smartphone 20 via the communication unit 18. The transferred logs 133 are recorded as having been transferred, and in the subsequent log transfer mode 50, only one or more newly generated, untransferred logs 133 are transferred. As described above, the transferred logs 133 are also stored in the storage 13 for 30 days without being deleted. During the log transfer mode 50, the history of the robot 10 is not recorded. Therefore, a stimulus received during the log transfer mode 50 is not reflected in the stimulus count information 36, and the number of times each of the automatically generated action and communication action has been performed during the log transfer mode 50 is not reflected in the action count information 37. Alternatively, the robot 10 may be configured to perform neither the automatically generated action nor the communication action during the log transfer mode 50. When the log transfer is completed, the CPU 11 returns the operating mode from the log transfer mode 50 to the normal mode 40.

The CPU 11 generates a log 133 at a first periodic time A3 after the end of the log transfer mode 50 as the special process and stores the generated log 133 in the storage 13. The log 133 generated at the periodic time A3 contains the information related to the history during a third period T3. The third period T3 is the period from the non-periodic time B to the periodic time A3 except the period during which the history has not been recorded due to the special process (duration of the log transfer mode 50). When generating the log 133 at the periodic time A3, the CPU 11 records the log time interval information 33 related to the length of the third period T3 in the log 133. For example, when the duration of the log transfer mode 50 in FIG. 6 is 3 minutes, the length of the third period T3 is 13 minutes obtained by subtracting 14 minutes of the second period T2 and 3 minutes of the log transfer mode 50 from 30 minutes of the first period T1. Therefore, when generating the log 133 at the periodic time A3, the CPU 11 records "13 minutes" as the log time interval information 33 in the log 133. The log 133 containing the information related to the history during the third period T3 may be distinguished from other logs 133 as a "third log". Thereafter, the CPU 11 generates logs 133 at respective periodic times A4, A5, and so forth for respective first periods T1.

FIG. 6 illustrates a case where the duration of the log transfer mode 50 does not overlap with any one of the periodic times A. However, the duration of the log transfer mode 50 may overlap with any one of the periodic times A. FIG. 7 illustrates the case where the duration of the log transfer mode 50 overlaps with the periodic time A3. In FIG. 7, it is assumed that the second period T2 is 29 minutes and the duration of the log transfer mode 50 is 3 minutes. In the example illustrated in FIG. 7, when generating a log 133 at the non-periodic time B, the CPU 11 records "29 minutes" as the log time interval information 33 in the log 133. In this case, the periodic time A3 overlaps with the log transfer mode 50, and thus a log 133 is not generated at the periodic time A3. The third period T3 is the period from the end of the log transfer mode 50 to the next periodic time A4, which is 28 minutes in length. Therefore, when generating a log 133 at the periodic time A4, the CPU 11 records "28 minutes" as the log time interval information 33 in the log 133.

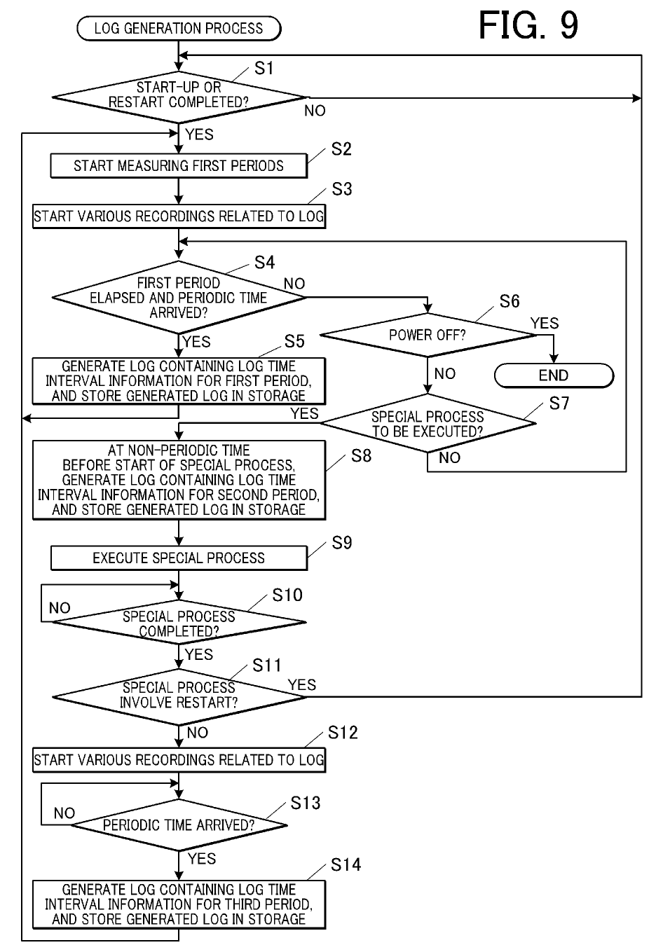

Next, a case where the special process is a FW update in the FW update mode will be described with reference to FIG. 8. In FIG. 8, after the log storage at the periodic time A2, a FW update request is transmitted from the smartphone 20 to the robot 10. Similar to the transfer request of the logs 133, the FW update request is transmitted from the smartphone 20 to the robot 10, for example, when the user instructs the smartphone 20 to update the FW on the management application. When the CPU 11 receives the FW update request, the CPU 11 changes the operating mode from the normal mode 40 to a FW update mode 60. When the robot 10 executes the transition to the FW update mode 60 as the special process, the CPU 11 executes irregular log storage at the non-periodic time B prior to the transition to the FW update mode 60, as in the cases illustrated in FIGS. 6 and 7.

The CPU 11 then changes the operating mode to the FW update mode 60 to execute the FW update. When the FW update is completed, the CPU 11 restarts the robot 10 to enable the updated FW. In FIG. 8, the period from the end of the FW update in the FW update mode 60 to the completion of the restart is shown as a blank period during which no operating mode is executed. During the FW update mode 60 and until the subsequent restart is completed, the history of the robot 10 is not recorded, and a log 133 is not generated. For example, in FIG. 8, the periodic time A3 arrives after the start of the FW update mode 60 and before the restart is completed, but a log 133 is not generated at the periodic time A3. When the restart is completed, the CPU 11 causes the robot 10 to operate in the normal mode 40. In addition, the CPU 11 starts measuring the first periods T1 from a time t1 when the restart is completed and then generates a log 133 at each of the periodic times A4, A5, and so forth every time the first period T1 elapses.

Next, a log generation process executed by the CPU 11 in order to realize the above operation will be described with reference to FIG. 9. The log generation process is started when the robot 10 is powered on. When the log generation process is started, the CPU 11 repeatedly determines whether processing related to starting or restarting the robot 10 has been completed (step S1). If the CPU 11 determines that the processing has been completed ("YES" in step S1), the CPU 11 starts measuring first periods T1 (30 minutes in the present embodiment) (step S2). The CPU 11 also starts various recordings related to a log 133 (step S3). For example, the CPU 11 counts, in step S3 and the subsequent steps, the number of times that a predetermined stimulus has been received from the outside or that a predetermined action has been performed. When the robot 10 enters the sleep mode in step S3 or thereafter, the CPU 11 records the elapsed time period of the sleep mode. The CPU 11 also records the emotion values and the personality values at the time of step S3.

The CPU 11 determines whether the first period T1 (30 minutes) has elapsed and a periodic time A has arrived (step S4). If the CPU 11 determines that a periodic time A has arrived ("YES" in step S4), the CPU 11 generates a log 133 containing the log time interval information 33 (30 minutes) for the first period T1 and stores the generated log 133 in the storage 13 (step S5). Here, the CPU 11 aggregates the various recordings started in step S3 to generate the log 133. When step S5 is completed, the CPU 11 resets the number of times the stimulus has been received, the number of times the predetermined action has been performed, and the sleep time, and the like, and returns the process to step S2. If the CPU 11 determines in step S4 that a periodic time A has not arrived ("NO" in step S4), the CPU 11 determines whether an operation to turn off the power of the robot 10 has been executed (step S6). If the CPU 11 determines that the operation has been executed ("YES" in step S6), the CPU 11 ends the log generation process. If the CPU 11 determines that the operation has not been executed ("NO" in step S6), the CPU 11 determines whether the special process is to be executed (step S7). For example, the CPU 11 determines that the special process is to be executed when the CPU 11 receives a transfer request of the log(s) 133 or a FW update request from the smartphone 20. If the CPU 11 determines that the special process is not to be executed ("NO" in step S7), the CPU 11 returns the process to step S4.

If the CPU 11 determines that the special process is to be executed ("YES" in step S7), the CPU 11 generates a log 133 containing the log time interval information 33 for a second period T2 at a non-periodic time B before the start of the special process and stores the generated log 133 in the storage 13 (Step S8). Here, the CPU 11 records the period from the previous periodic time A to the non-periodic time B in the log 133 as the log time interval information 33 for the second period T2. In addition, the CPU 11 aggregates the various recordings started in step S3 to generate the log 133. The CPU 11 then executes the special process (step S9). For example, when the CPU 11 has received a transfer request of the log(s) 133, the CPU 11 changes the operating mode to the log transfer mode 50 and transmits the log(s) 133 untransferred at that time to the smart phone 20. When the CPU 11 has received a FW update request, the CPU 11 executes a FW update. The CPU 11 repeatedly determines whether the special process has been completed (step S10). If the CPU 11 determines that the special process has been completed ("YES" in step S10), the CPU 11 determines whether the special process involves a restart of the robot 10 (step S11). If the CPU 11 determines that the special process involves the restart ("YES" in step S11), the CPU 11 returns the process to step S1. For example, when the special process is a FW update, the CPU 11 branches the process to "YES" in step S11. Then, when the restart has been completed ("YES" in step S1), the CPU 11 starts measuring the first periods T1 again (step S2).

If the CPU 11 determines that the special process does not involve the restart ("NO" in step S11), the CPU 11 starts various recordings related to a log 133 (step S12). The CPU 11 repeatedly determines whether a periodic time A has arrived (step S13). At this point, no restart has been performed since the last execution of step S2. Therefore, the measurement of the first period T1 started in step S2 has not been reset. Accordingly, the periodic time A in step S13 is the time at which an integer multiple of the first period T1 has elapsed for the first time since the measurement of the first periods T1 was started in the last executed step S2. If the CPU 11 determines that a periodic time A has arrived ("YES" in step S13), the CPU 11 generates a log 133 containing the log time interval information 33 for the third period T3 and stores the generated log 133 in the storage 13 (step S14). Here, the CPU 11 records the period from the completion of the special process to the periodic time A in the log 133 as the log time interval information 33 for the third period T3. In addition, the CPU 11 aggregates the various recordings started in step S12 to generate the log 133. When step S14 is completed, the CPU 11 resets the number of times the stimulus has been received, the number of times the predetermined action has been performed, and the sleep time, and the like, and returns the process to step S2.

In FIG. 9, the CPU 11 determines in step S6 whether the operation to turn off the power of the robot 10 has been executed, but the CPU 11 may receive the operation at any other time. When the CPU 11 receives the operation to turn off the power, the CPU 11 ends the log generation process and immediately (e.g., in less than one second) turns off the power of robot 10. When the CPU 11 turns off the power of the robot 10 in response to the operation on the operation unit 14 as described above, the CPU 11 does not generate a log 133 because there is no time to generate the log 133. However, generating a log 133 may be prioritized, and the power of the robot 10 may be turned off once the log 133 is generated and stored.

In the above description, the process to generate the log 133 for the second period (step S8) is exemplified as the "predetermined process to generate a log for the second period", but the predetermined process is not limited thereto. For example, when there is sufficient capacity in the RAM 12, flagging may be performed in step S8 to delimit the second period T2, and at any later time, the second period T2 may be specified based on the flag to generate the log 133 for the second period T2. The flag to delimit the second period T2 includes at least data that indicates the time when the second period T2 ended.

As described above, the robot 10 according to the present embodiment includes the CPU 11 that generates logs 133 at respective periodic times A for respective first periods T1 of a predetermined length, the logs 133 containing at least the information related to the action history (operation history) of the robot 10 during the respective first periods T1. In addition, in response to the robot 10 executing the special process that may prevent a log 133 from being generated at a corresponding periodic time A, the CPU 11 executes a predetermined process to generate a log 133 for a second period T2 from the last periodic time before the corresponding periodic time A to a time before the start of the special process. Accordingly, even when a log 133 cannot be generated at the corresponding periodic time A due to the special process, the log 133 for the second period T2 from the last periodic time before the corresponding periodic time A to the time before the start of the special process can be generated. In the related art, when the electronic device performs a special process that prevents log generation at a periodic time of log generation, a log cannot be generated at that periodic time of log generation.

The robot 10 according to the present embodiment can also record the history immediately before the start of the special process, which has not been recorded in the related art, as reflected in a log 133. Thus, it is possible to generate logs 133 that suitably reflect the history.

The predetermined process includes the process to generate the log 133 for the second period T2. Accordingly, when the special process is started, the log 133 for the second period T2 can be generated at a suitable time (at the time of the start of the special process).

When generating the log 133 for the second period T2, the CPU 11 records the log time interval information 33 related to the length of the second period T2 in the log 133. A log 133 generated at a non-periodic time B has a shorter log recording period than the log 133 generated at any one of the periodic times A, and thus the amount of the information related to the history contained in the log 133 generated at the non-periodic time B becomes smaller. On the other hand, by recording the log time interval information 33 related to the length of the second period T2 in the log 133 as described above, it is possible to determine the density of the information contained in the log 133. Therefore, it is possible to analyze the history while taking into account differences in the density of the information in each log 133. This allows for suitable comparison between logs 133 having different log recording periods while standardizing the format of logs 133 for any given period.

The CPU 11 executes the predetermined process at the non-periodic time B, which is different from any one of the periodic times A and is the time before the start of the special process. Accordingly, even when the special process is started at any time other than the periodic times A, the history immediately before the start of the special process can also be reflected and recorded in the log 133.

The CPU 11 generates a log 133 containing the information related to the history during a third period T3 at the first periodic time A after the completion of the special process. The third period T3 is the period from the non-periodic time B to the first periodic time A after the completion of the special process except the period during which the history has not been recorded due to the special process from. This allows the history immediately after the completion of the special process to be reflected and recorded in the log 133. Thus, it is possible to generate logs 133 that more suitably reflect the history.

When generating the log 133 at the first periodic time A3 after the completion of the special process, the CPU 11 records the log time interval information 33 related to the length of the third period T3 in the log 133. This makes it possible to determine the density of the information contained in the log 133.

When the robot 10 is restarted after the special process, the CPU 11 starts measuring the first periods T1 from the time when the restart is completed. This makes it possible to generate logs 133 that suitably reflect the history after the restart.

Examples of the special process include transmitting one or more logs 133 to the smartphone 20 and updating the firmware incorporated in the robot 10. Accordingly, even when the robot 10 executes these special processes, logs 133 that more suitably reflect the history can be generated.

A log 133 contains information related to at least one of the following: the number of times or the frequency of a predetermined action that the robot 10 has performed during the log recording period (first period T1, second period T2, or third period T3); the number of times or the frequency of a predetermined stimulus that the robot 10 has received from the outside during the log recording period; the length of a period during which the robot 10 has been in a predetermined state in the log recording period; or the state of the robot 10 at a predetermined time point in the log recording period. This makes it possible to generate a log 133 in a package format in which the history of the robot 10 during the log recording period is summarized into a predetermined number of items. This also makes it possible to standardize the format of logs 133 for any given period regardless of the length of the log recording period or the number of events (the number of actions of the robot 10 or external stimuli to be recorded). This greatly reduces the amount of data in a log 133 compared to a log in a sequential recording format. In addition, even when the storage capacity of the storage 13 is small, the history can be recorded over a long period of time.

The first period T1 has such a length that allows the logs 133 generated for the respective first periods T1 over a predetermined recording period to be stored in the storage 13, based on the amount of data to be generated in each log 133 and, in the storage 13, the data capacity of a region in which the logs 133 are to be stored. Accordingly, the logs 133 generated for the respective first period T1 over the predetermined recording period can be stored in the storage 13, and logs 133 can be generated as frequently as possible within a range that satisfies this condition.

According to a log generation method according to the present embodiment, the CPU 11 can generate logs 133 that suitably reflect the history by executing the above-described operations. The programs 131 according to the present embodiment cause the CPU 11 to serve as a processor that executes the above-described operations. This makes it possible to generate logs 133 that suitably reflect the history.

The present disclosure is not limited to the above embodiment, and various modifications are possible. For example, the log transfer mode 50 and the FW update mode 60 are exemplified as the special process that may prevent a log 133 from being generated, but the present disclosure is not limited thereto. The special process may be any process that may prevent a log 133 from being generated at any one of the periodic times A.

The configuration of the robot 10 is not limited to the configuration illustrated in FIGS. 1 to 3. For example, a robot imitating an existing living being such as a person, an animal, a bird, or fish, a robot imitating a non-existing living being such as a dinosaur, a robot imitating an imaginary living being, or the like may be used.

The electronic device is not limited to the robot 10 and may be any device including a processor that generates a log of the device itself.

In the above description, an example has been disclosed in which a flash memory is used for the storage 13 as a computer-readable medium storing the program according to the present disclosure, but the present disclosure is not limited thereto. As another computer-readable medium, an information recording medium such as a hard disk drive (HDD), a solid-state drive (SSD) or a CD-ROM may be applied. A carrier wave is also applied to the present disclosure as a medium that provides data of the program according to the present disclosure via a communication line.

The detailed configuration and the detailed operation of each component of the robot 10 and the smartphone 20 in the above embodiments can be appropriately changed without departing from the gist of the present disclosure.

Although the embodiments according to the present disclosure have been described, the scope of the present disclosure is not limited to the above-described embodiments and includes the scope of the invention as described in the claims and equivalents thereof.

1. An electronic device comprising one or more processors configured to:
generate first logs at respective periodic times for respective first periods of a predetermined length, the first logs containing at least information related to an operation history of the electronic device during the respective first periods; and,
in response to the electronic device executing a special process that is capable of preventing one of the first logs from being generated at a corresponding periodic time, execute a predetermined process to generate a second log for a second period from a last periodic time before the corresponding periodic time to a time before a start of the special process, wherein the second log contains at least the information related to the operation history of the electronic device during the second period.

2. The electronic device according to claim 1, wherein the predetermined process includes a process to generate the second log for the second period.

3. The electronic device according to claim 2, wherein, when the one or more processors generate the second log for the second period, the one or more processors record time information related to a length of the second period in the second log.

4. The electronic device according to claim 1, wherein the one or more processors execute the predetermined process at a non-periodic time that is different from any one of the periodic times and that is the time before the start of the special process.

5. The electronic device according to claim 4, wherein
the one or more processors generate a third log at a first periodic time after a completion of the special process,
the third log contains at least the information related to the operation history of the electronic device during a third period, and
the third period is a period from the non-periodic time to the first periodic time after the completion of the special process except a period during which the
operation history has not been recorded due to the special process.

6. The electronic device according to claim 5, wherein, when the one or more processors generate the third log at the first periodic time after the completion of the special process, the one or more processors record time information related to a length of the third period in the third log.

7. The electronic device according to claim 1, wherein, when the electronic device is subjected to a restart after the special process, the one or more processors start measuring the first periods from a time when the restart is completed.

8. The electronic device according to claim 1, wherein the special process includes:
transmitting at least one of the first logs or the second log to an external device; and
updating firmware incorporated in the electronic device.

9. The electronic device according to claim 1, wherein
the first logs contain information related to at least one of:
a number of times or a frequency of a predetermined action that the electronic device has performed during the respective first periods;
a number of times or a frequency of a predetermined stimulus that the electronic device has received from an outside during the respective first periods;
a length of a period during which the electronic device has been in a predetermined state in the respective first periods; or
a state of the electronic device at a predetermined time point in the respective first periods, and
the second log contains the information related to at least one of:
the number of times or the frequency of the predetermined action that the electronic device has performed during the second period;
the number of times or the frequency of the predetermined stimulus that the electronic device has received from the outside during the second period;
the length of the period during which the electronic device has been in the predetermined state in the second period; or
the state of the electronic device at the predetermined time point in the second period.

10. The electronic device according to claim 1, wherein
the one or more processors store the generated first logs and the generated second log in a storage, and,
based on
an amount of data to be generated in each of the first logs and,
in the storage, data capacity of a region in which the first logs are to be stored,
the first period has such a length that allows the first logs generated for the respective first periods over a predetermined recording period to be stored in the storage.

11. A method for generating a log that includes:
first logs containing at least information related to an operation history of an electronic device during respective first periods of a predetermined length; and
a second log containing at least the information related to the operation history of the electronic device during a second period,
the method comprising:
causing a computer of the electronic device to generate the first logs at respective periodic times for the respective first periods; and,
in response to the electronic device executing a special process that is capable of preventing one of the first logs from being generated at a corresponding periodic time, causing the computer to execute a predetermined process to generate the second log for the second period from a last periodic time before the corresponding periodic time to a time before a start of the special process.

12. A non-transitory computer-readable recording medium storing a program that:
causes a computer of an electronic device to generate first logs at respective periodic times for respective first periods of a predetermined length, the first logs containing at least information related to an operation history of the electronic device during the respective first periods; and,
in response to the electronic device executing a special process that is capable of preventing one of the first logs from being generated at a corresponding periodic time, causes the computer to execute a predetermined process to generate a second log for a second period from a last periodic time before the corresponding periodic time to a time before a start of the special process, wherein the second log contains at least the information related to the operation history of the electronic device during the second period.
